(19) United States
(12) Patent Application Publication
(10) Pub. No.: US 2003/0147331 A1
(43) Pub. Date: Aug. 7, 2003

(54) Optical pickup diffracting one of two laser beams to a single detector

(75) Inventor: Wai-Hon Lee, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: G-BOND Optoelectronics, Inc., Milpitas, CA (US)

(21) Appl. No.: 10/071,152

(22) Filed: Feb. 7, 2002

(51) Int. Cl. G11B 7/135

(52) U.S. Cl. 369/112.11; 369/120

(57) ABSTRACT

An optical pickup with two lasers for CD and DVD uses a grating to diffract one beam to the detector used by the other beam. This requires only one beam to be diffracted, allowing the diffraction pattern to be varied to compensate for different spacings between the lasers. A single, 4-quadrant detector is used to detect the returned beams from both lasers. The returned beam of the first laser passes through the grating element undiffracted, by passing through a portion without a grating pattern. The position of the detector is aligned with respect to this first beam. The grating diffracts the returned beam from the second laser to the same detector. The separation of the grating from the detector can be adjusted so that the returned beam from the second laser is also perfectly aligned with the detector.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates to optical pickups that work with both CDs and DVDs, and in particular to a design allowing the use of a single detector.

Digital Versatile Disc (DVD) is a new format for storing video information. One of such disc can store a movie lasting more than two hours. In order to read the densely recorded digital data from DVD discs, the laser spot on the disc must be less than 0.55 μm. This requires using a laser with 650 nm wavelength or less and an objective lens with numerical aperture (NA) of 0.6 in the optical pickup. To facilitate the design of such a lens, the thickness of the DVD disc was specified to be 0.6 mm instead of the 1.2 mm thickness for CD discs. The differences between a DVD optical system and a CD optical system are summarized in Table 1.

TABLE 1

| | CD | DVD |
|---|---|---|
| Laser Wavelength (λ) | 780 nm | 650 nm |
| Numerical Aperture (NA) | 0.45 | 0.6 |
| Spot size (λ/2NA) | 0.87 μm | 0.54 μm |
| Disc thickness | 1.2 mm | 0.6 mm |

It is difficult to design an objective lens to properly focus a laser beam through two substrates with different thickness. Fortunately, this difficulty is solved by researchers in this reference article: Jang-hoon Yoo et.al. “An Optical Head with Special Annular Lens for Laser Disc-Compatible Digital Versatile Disc Pickup” Jpn. J.Appl. Phys. Vol. 37, pp.2184-2188, Part 1 No. 48, April 1988. With this particular objective lens design, a DVD optical pickup using 650 nm laser can read both the CD disc and the DVD disc. However, for historical reasons, the CD-Recordable (CD-R) discs contain a dye, which can only be detected by 780 nm lasers. As a result, most DVD optical pickups today contain two lasers: one with 780 nm wavelength for reading the CD discs including the CD-R and CD-RW discs and one with 650 nm wavelength for reading DVD discs.

In a traditional one laser system such as shown in FIG. 1 there is only one optical axis. The light emitted by the laser package 101 will pass through a 3-beam grating 102. The laser light is then reflected by half mirror 103, collimated by a lens 104 and finally focused by objective lens 105 to medium 106. The light reflected by the medium 106 again passes through lenses 105 and 104. A portion of this reflected light is transmitted through the half mirror 103 and focused on detector 107.

A typical pattern on the detector is shown in FIG. 1(b). Light sensitive elements, 107a, 107b, 107c and 107d are for detecting the focusing condition of the objective lens as well as the information read from the disc. Light sensitive elements, 107e and 107f are for detecting tracking error signals.

As illustrated in FIG. 2, one of the difficulties in having two lasers in the same optical pickup is the need to use a dichroic beam splitter to efficiently combine the light emitted by the two lasers. The dichroic beam splitter 201c will reflect 100% of the light beam from laser chip 201b and transmit 100% of the light beam from laser chip 201a. The cube dichroic beam splitter requires bonding two highly polished prisms with proper dielectric coating together to form a cube. As a result, the cost of dichroic beam splitter is high. The advantage of using a dichroic beam splitter to combine two laser beams is that after combination, both beams appear to come from the same point source and propagate along the same optical axis. Both beams are reflected by the medium and are focused on the detector 207. In manufacturing such an optical pickup, the position of the detector 207 is aligned to the first laser. The position of the second laser must then be adjusted so that its beam is focused properly on the same detector.

Recently, semiconductor laser manufacturers came out with a package that contains both a 780 nm laser chip and a 635-650 nm laser chip. The emitting point of the laser is separated by about 120 μm (micrometer) as shown in FIG. 3. Laser chip 302 and laser chip 303 are mounted side by side on heat sink 301, which is part of the laser package 300. A preferred arrangement is to have the laser channels at equal distances from the center axis 304 of the package. Of course, it is also possible to have the laser channel of chip 303 on the center axis and the laser channel of chip 302 off to one side of the center axis. A detector 305 is used to detect the back emission from both lasers. Such a twin laser package is used to replace the single laser package 101 in an optical pickup as shown in FIG. 1. The optical system with the twin laser package in most aspects remains unchanged except for the detector package 107.

Because the two laser emitting points are separated in space, their images on the detector are similarly separated. As a result, a new detector pattern as shown in FIG. 4 is needed. Two sets of quadrant detectors are used to detect the returned beams from each of the lasers. The difficulty with this approach is that there is a manufacturing tolerance on the separations between the two laser chips. As a result, it is difficult to align the two beams perfectly on the detectors with a fixed separation. If the separation of the laser chips varies, the separation of the detectors on the detector chip would need to vary by the same amount. A standard detector chip with a standard separation of the detectors will suffer performance degradation if the lasers are not precisely mounted at the appropriate separation.

An example of a system with two lasers for CD and DVD which uses a diffraction grating to project return beams from two lasers onto two different detectors is set forth in Sanyo U.S. Pat. No. 5,717,674.

### BRIEF SUMMARY OF THE INVENTION

It is the purpose of this patent application to solve the aforementioned problem. A grating is placed at a slight distance in front of the detector. A single, 4-quadrant detector is used to detect the returned beams from both lasers. The returned beam of the first laser passes through the grating element undiffracted, by passing through a portion without a grating pattern. The position of the detector is aligned with respect to this first beam. The grating diffracts the returned beam from the second laser to the same detector. The separation of the grating to the detector can be adjusted so that the returned beam from the second laser is also perfectly aligned to the detector.

In manufacturing, the separation of the laser sources is set to a typical distance such as 150 micrometers, and an appropriate grating created for that separation. During manufacturing, the diffraction element is adjusted along the optical axis to correct for the small error in the separation of the two laser chips.

### BRIEF DESCRIPTION OF THE DRAWINGS

FIG. 1(a) illustrates a prior art single laser optical pickup.

FIG. 1(b) illustrates a typical prior art detector.

FIG. 2 illustrates a prior art two-lasers optical pickup.

FIG. 3 illustrates a prior art dual laser package.

FIG. 4 illustrates a prior art detector used with the dual laser package.

FIG. 5(a) illustrates a preferred embodiment of an optical pickup of this present invention.

FIG. 5(b) illustrates a detailed view of the grating and detector of the optical pickup of FIG. 5.

FIG. 6 illustrates a second preferred embodiment of the detector for this present invention.

### DETAILED DESCRIPTION OF THE INVENTION

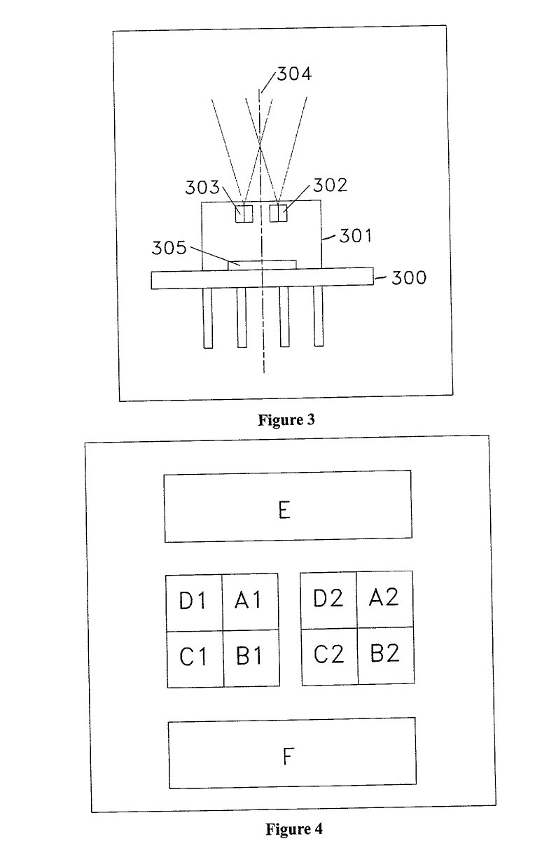

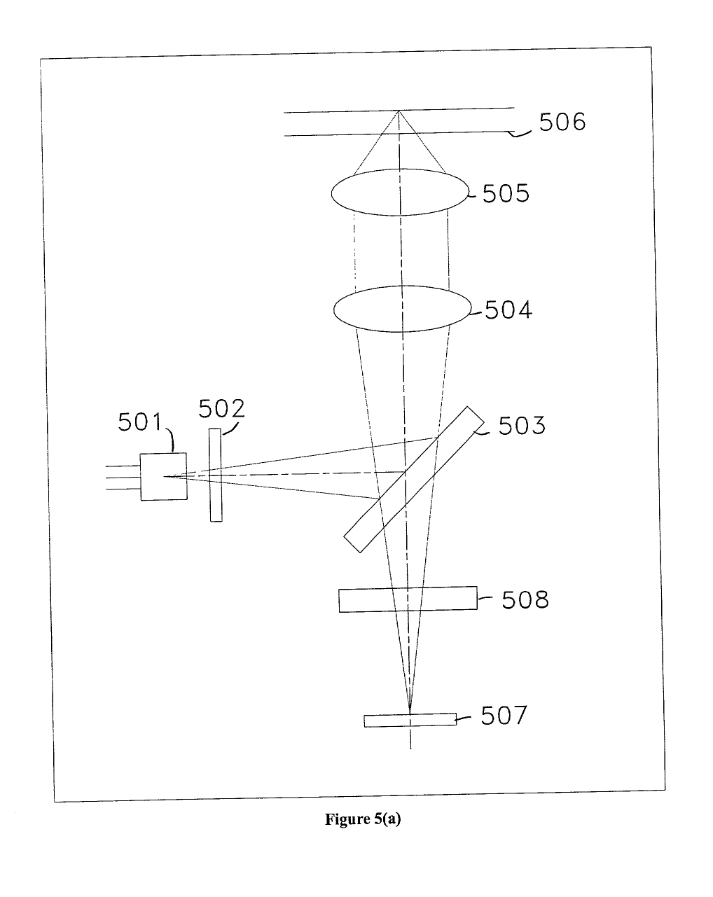

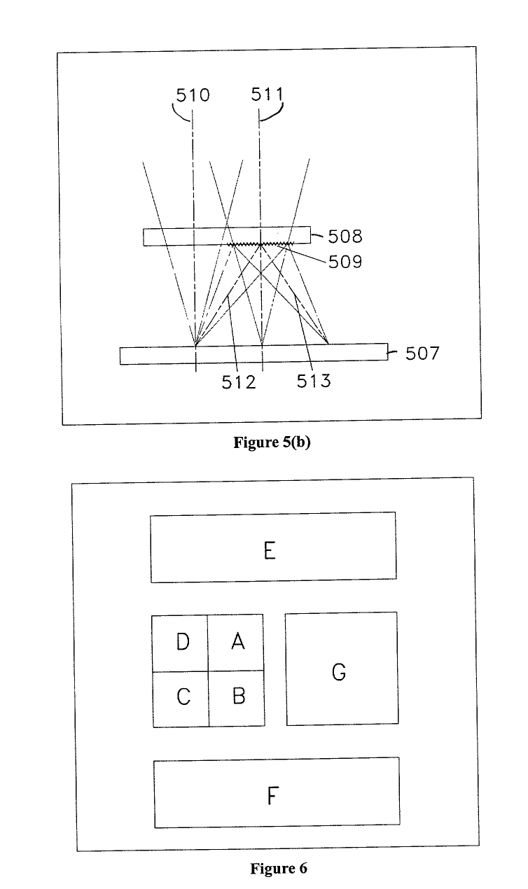

In FIG. 5(a) the laser package 501 contains two laser chips similar to the package in FIG. 3. The laser beams, after passing through a 3-beam grating 502, are reflected by the half mirror (beam-splitter) 503. The beams are then collimated by a collimating lens 504 and focused by the objective lens 505 onto the medium 506. To simplify the discussion, a first laser is set along the optical axis of the objective lens. The returned beams, after passing through again the objective lens and the collimating lens, are transmitted through the half mirror. Both beams are intercepted by a grating glass 508 before being projected on the detector 507.

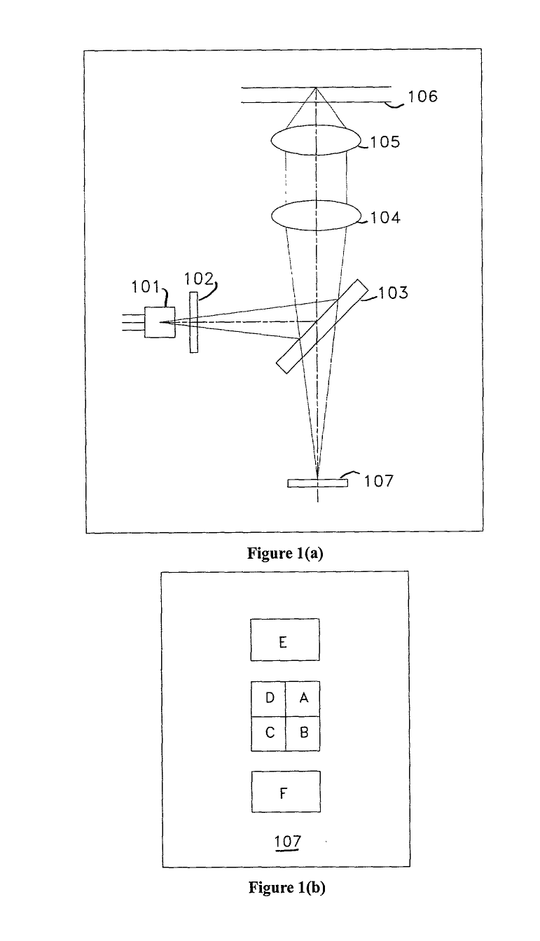

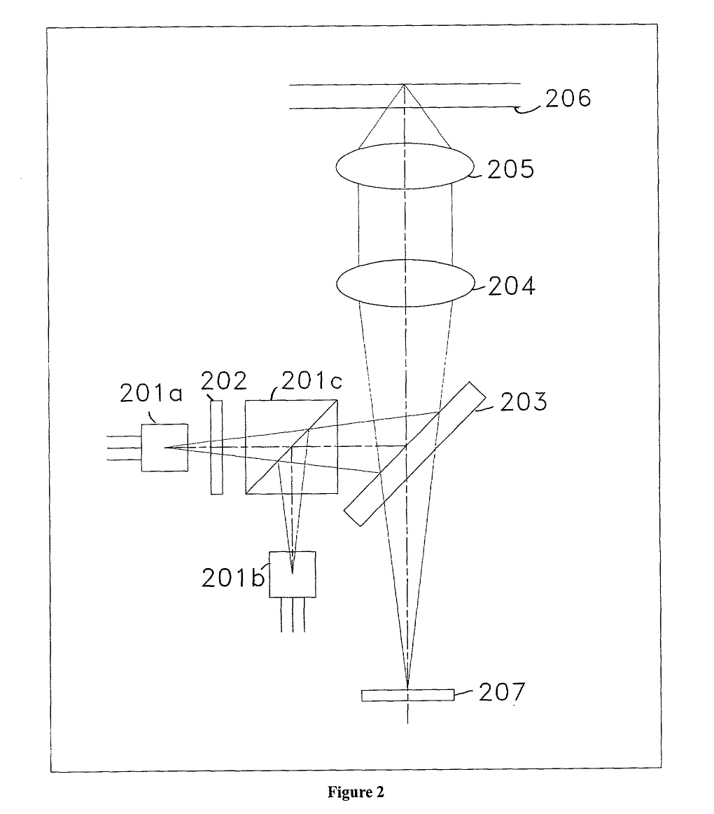

FIG. 5(b) shows the details of the two returned beams. The line 510 is the optical axis of the first laser and the line 511 is the optical axis of the second laser. The grating glass 508 is placed at a distance from the detector 507 such that the two returned beams are separated in space. In a first embodiment of the present invention a grating 509 is etched on the grating glass 508 in such a manner that it only intercepts the returned beam 511. Since the beam with optical axis 510 is not intercepted by grating 509, it passes through 508 without deviation and falls on detector 507. Grating 509 diffracts the beam 511 into two beams 512 and 513. By means of the grating 509, the beams from the first laser 510 and the second laser 511 are brought into coincidence on the same detector 507. As a result, the same detector as shown in FIG. 1(b) can be used for both laser sources. In this present invention the two laser beams are combined on the detector plane without the use of a dichroic beam splitter. In a second embodiment, both beam will pass through grating 509. However, the grating is made in such a manner that the grating is transparent to the beam 510 with a first wavelength and diffracts the beam 511 with the second wavelength.

In a typical use, the optical pickup is reading either a CD or a DVD, so only one of those laser signals needs to be read at a time.

In manufacturing, a single diffraction element could be used, but its distance from the detector (adjusting along the optical axis) could be varied to compensate for the difference in spacing between the laser sources. This same method could be applied with both beams being diffracted. The varying distance could compensate for different separations of the laser source.

Either laser could be the one to have its beam diffracted. In a preferred embodiment, the 780 nm beam is diffracted, because its signal is typically stronger, and can better afford to have some reduced intensity by diffraction.

FIG. 6 shows a second embodiment of a detector for this present invention. In addition to the detector a, b, c, d, e and f in FIG. 1(b), detector g is added to collect the diffracted beam 513. The signal generated by detector g can be added to the sum of the signal from detectors a, b, c and d to increase the level of the high frequency signal when the second laser is used. The sum signal is the signal used to give the data, whether it is a digital one or zero. The g signal would not be combined with the signals from each quadrant, which are used for focus error correction.

As will be understood by those of skill in the art, the present invention may be embodied in other specific forms without departing from the essential characteristics thereof. For example, the two lasers could be in separate packages, or a different number of detector quadrants could be used. Alternately, the laser beams could be on either side of the optical axis of the objective lens, instead of one being on that axis. Additionally, instead of correcting by adjusting along the optical axis, the pattern of the grating could be modified. Accordingly, the above description is intended to be illustrative, but not limiting, of the scope of the invention which is set forth in the following claims.

What is claimed is:

1. An optical apparatus for directing first and second laser sources to a media, then directing reflected light to a detector, the improvement comprising:
a single detector for detecting reflected light from both of said laser sources; and
a grating having a surface configured to diffract reflected light from said first laser source to said detector, and allowing reflected light from said second laser source to pass directly to said detector without diffraction.

2. The apparatus of claim 1 wherein said surface includes:
a first surface with a grating for diffracting reflected light from said first laser source, and a second surface without a grating for allowing reflected light from said second laser source to pass without diffraction.

3. The apparatus of claim 1 wherein said surface includes:
a grating having a pattern configured to diffract reflected light of the wavelength of said first laser source, and allow reflected light of the wavelength of said second laser source to pass without diffraction.

4. The apparatus of claim 1 wherein said optical apparatus includes:
a beam splitter positioned to split the light from the laser sources and the reflected light so that the laser sources and the detector can be mounted at an angle to each other.

5. The apparatus of claim 1, wherein said optical apparatus includes:
a 3-beam grating positioned to split the light from each of said laser sources into 3 beams before contacting said media.

6. The apparatus of claim 1, wherein said optical apparatus includes:
a collimating lens positioned between said laser sources and said medium; and
an objective lens positioned between said collimating lens and said medium.

7. The apparatus of claim 6, wherein said laser sources have different wavelengths, and an optical axis of each of said laser sources, at a point of entering said objective lens, is parallel to an axis of said objective lens.

8. The apparatus of claim 1 wherein said detector is a four element detector.

9. The apparatus of claim 8, wherein said detector is on a chip having a second detector positioned to collect light from other orders of the diffracted reflected light from said first laser and a circuit for combining a signal from said second detector with a signal from said detector for said first laser.

10. An optical apparatus for directing first and second laser sources to a media, then directing reflected light to a detector, the improvement comprising:
a 3-beam grating positioned to split the light from each of said laser sources into 3 beams before contacting said media;
a beam splitter positioned to split the light from the laser sources and the reflected light so that the laser sources and the detector can be mounted at an angle to each other;
a collimating lens positioned between said laser sources and said medium;
an objective lens positioned between said collimating lens and said medium.
wherein said laser sources have different wavelengths, and an optical axis of each of said laser sources, at a point of entering said objective lens, is parallel to an axis of said objective lens;
a single four element detector for detecting reflected light from both of said laser sources; and
a grating having a first surface with a grating configured to diffract reflected light from said first laser source to said detector, and having a non grating surface for allowing reflected light from said second laser source to pass directly to said detector without diffraction.

11. An improved method for directing first and second laser sources to a media, then directing reflected light to a detector, the improvement comprising:
providing a single detector for detecting reflected light from both of said laser sources; and
diffracting reflected light from said first laser source to said detector, and allowing reflected light from said second laser source to pass directly to said detector without diffraction.

12. The method of claim 11 further comprising:
determining a separation of said laser sources; and
varying a distance of a diffraction grating from said detector to direct reflected light with said separation to said detector.

13. The method of claim 11 further comprising:
determining a separation of said laser sources; and
forming a diffraction pattern to direct reflected light with said separation to said detector.
